(19) United States
(12) Patent Application Publication
(10) Pub. No.: US 2007/0087629 A1
(43) Pub. Date: Apr. 19, 2007

(54) Electrical connector

(76) Inventor: Shih-Chieh Liang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/526,656

(22) Filed: Sep. 26, 2006

(30) Foreign Application Priority Data
Oct. 13, 2005 (TW) 094135628

(51) Int. Cl. H01R 13/648

(52) U.S. Cl. 439/607

(57) ABSTRACT

An electrical connector has a rectangular insulative housing, a plurality of terminals received in the insulative housing, a shell enveloping the insulative housing, and a grounding plate assembled on the insulative housing. The grounding plate includes a connecting portion, a plurality of distal ends extending from the connecting portion, and lock portions extending from both ends of the connecting portion for resiliently holding a rear edge of shell. The grounding plate resiliently locks a rear side of the shell for grounding when the grounding plate is assembled to the insulative housing.

### BACKGROUND OF THE INVENTION

1. Field of the Invention

The present invention relates to an electrical connector, and particularly to an electrical connector adapted for Low Voltage Differential Signal display interface.

2. Related Art

In recent years socket connectors are popularly used in panel products, which are also called electrical connectors for Low Voltage Differential Signal. Such an electrical connector is welded to a circuit board and electrically connects a cable with the circuit board. Demand of low profile restrains the structural design of the electrical connector, especially configurations of a metal shell, signal terminals and grounding components. Holding force of the electrical connector and coupling strength between elements thereof should be under consideration as well. In general, the metal shell envelopes an insulative housing of the electrical connector for enhancing strength of the insulative housing. Meanwhile the metal shell contacts a grounding component, thereby avoiding electromagnetic or electrostatic interference.

FIG. 1 shows a schematic partial view of a simplified conventional electrical connector. The conventional electrical connector includes an insulative housing 1, terminals 2, a grounding plate 3 and a metal casing 4. A grounding spring 5 extends from a side of the grounding plate 3, and exactly into a recess 6 of the insulative housing 1 with a part thereof resiliently and upwardly beyond a surface of the insulative housing 1. The grounding spring 5 upwardly abuts the metal casing 4 for electrically communicating the metal casing 4 and the grounding plate 3 when the metal casing 4 is assembled. However, in this way, probably the grounding spring 5 cannot contact the metal casing 4 provided that the grounding spring 5 extends upwardly at too small angle. Additionally, the grounding plate 3 is not fixed reliably, and consequently may eject out after the electrical connector has been used repeatedly.

### SUMMARY OF THE INVENTION

Accordingly, an object of the present invention is to provide an electrical connector grounding stably.

Another object of the present invention is to provide an electrical connector which has simplified structure and is readily assembled and which reduces fraction defective in process of manufacture.

A further object of the present invention is to provide an electrical connector preventing deformation between components thereof.

The electrical connector of the present invention comprises a rectangular insulative housing defining a plurality of passageways therein, a plurality of terminals received in the passageways, a shell enveloping the insulative housing, and a grounding plate assembled on the insulative housing. An opening is defined through a front surface of the insulative housing for receiving a mating flexible cable. The grounding plate includes a connecting portion, a plurality of distal ends extending from the connecting portion, and lock portions extending from both ends of the connecting portion for resiliently holding a rear side of shell.

Inverted U-shaped latches are formed on both sides of the shell for being retained to side walls of the insulative housing.

Alternatively, a pair of separate latching elements are mounted on the insulative housing. Stop portions are formed on the shell for limiting the latching elements.

### BRIEF DESCRIPTION OF THE DRAWINGS

FIG. 1 is a schematic partial view of a simplified conventional electrical connector.

FIG. 2 is a perspective view of an electrical connector according to a first embodiment of the present invention.

FIG. 3 is a perspective view of the electrical connector from another aspect.

FIG. 4 is an exploded view of the electrical connector of FIG. 3.

FIG. 5 is an enlarged partial view of a shell of the electrical connector of FIG. 3.

FIG. 6 is an enlarged plane view of a grounding plate of the electrical connector of FIG. 3, wherein only a part thereof is shown.

FIG. 7 is an exploded view of an electrical connector according to a second embodiment of the present invention.

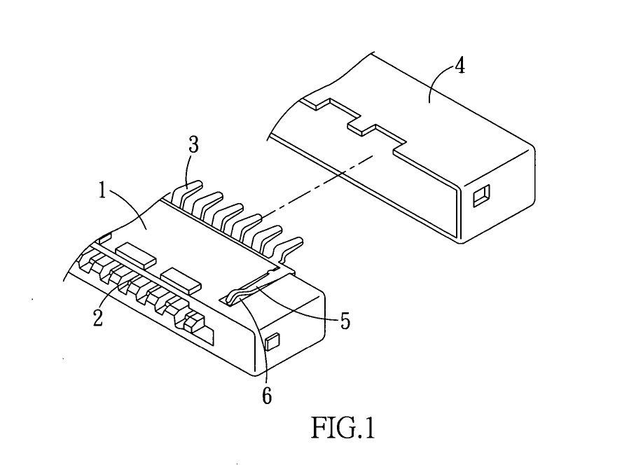

### DESCRIPTION OF THE PREFERRED EMBODIMENTS

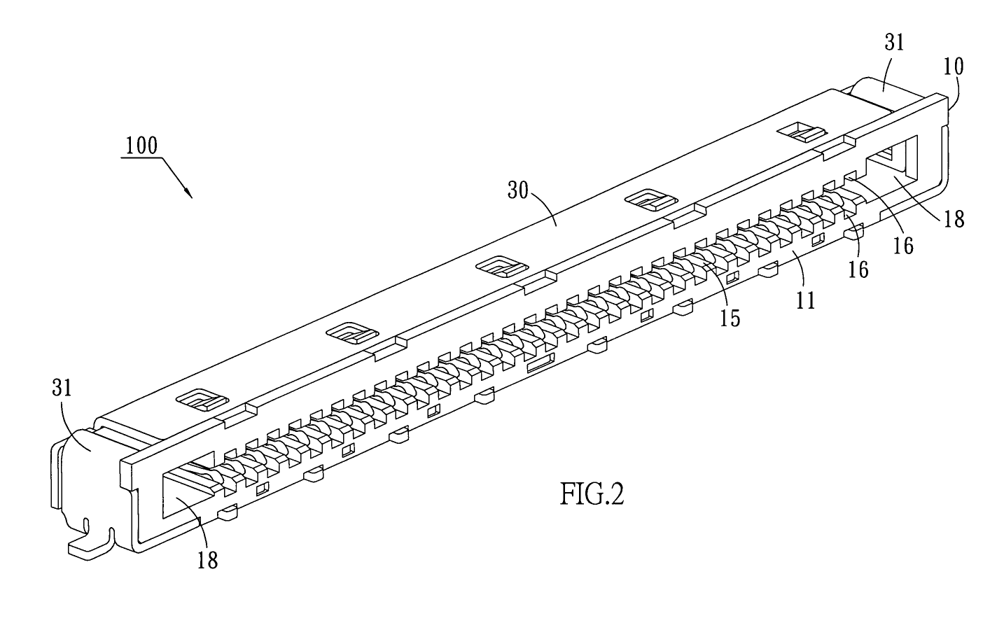

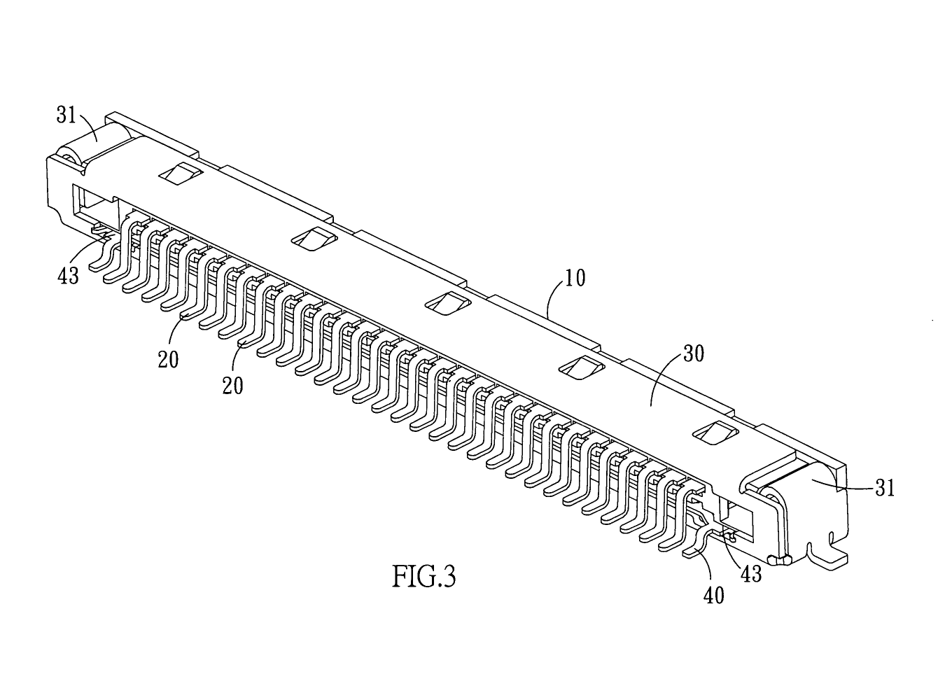

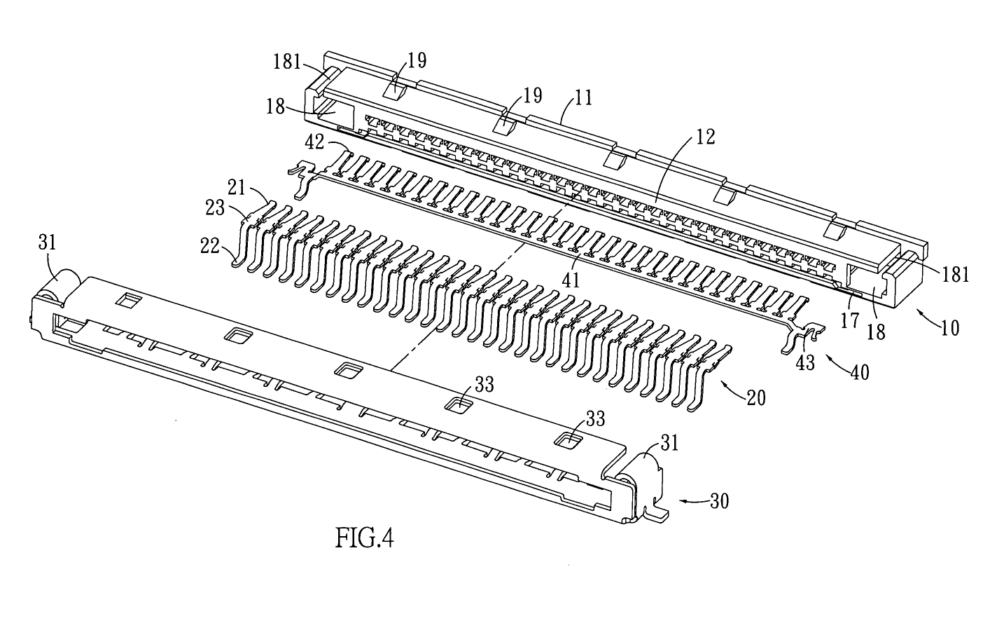

With reference to FIGS. 2, 3 and 4, an electrical connector 100 according to a first embodiment of the present invention comprises an insulative housing 10, a plurality of terminals 20 received in the insulative housing 10, a shell 30 and a grounding plate 40. The insulative housing 10 is substantially rectangular and made of plastic. An opening 15 is defined through a front surface 11 of the insulative housing 10 for receiving a mating flexible cable (not shown), as shown in FIG. 2. A plurality of upper and lower passageways 16 is respectively defined at an upper surface and a lower surface of the opening 15. Fixing grooves 17 extend downwardly from opposite sides of the insulative housing 10 and through a rear surface 12 of the insulative housing 10. The fixing grooves 17 respectively communicate with the lower passageways 16. Cavities 18 are respectively defined at opposite sides of the opening 15 and through the front surface 11 and the rear surface 12. Slits 181 are respectively defined above the cavities 18.

The terminals 20 are received in the individual passageways 16 of the insulative housing 10. Each terminal 20 comprises a contact end 21, a soldering end 22 and an intermediate portion 23 between the contact end 21 and the soldering end 22. In assembly, the terminals 20 are brought to extend from the rear surface 12 of the insulative housing 10 and into the upper passageways 16. The intermediate portions 23 are interferentially fixed on the insulative housing 10. The soldering ends 22 remain outside the rear surface 12 of the insulative housing 10 for electrically connecting with and being retained on a circuit board (not shown).

The shell 30 is made of metal and is of a frame shape fitting for the insulative housing 10. Further referring to FIG. 5, latches 31 are formed on both sides of the shell 30 and have inverted-U shape respectively. Each latch 31 includes a base 311, a curve portion 312 bending inwardly from an end of the base 311, and an inner portion 313 extending downwardly from an end of the curve portion 312. A slot 314 is defined in the inner portion 313 for engaging with the mating flexible cable. A plurality of orifices 33 are defined in the shell 30 for interferentially retains protrusions 19 of the insulative housing 10.

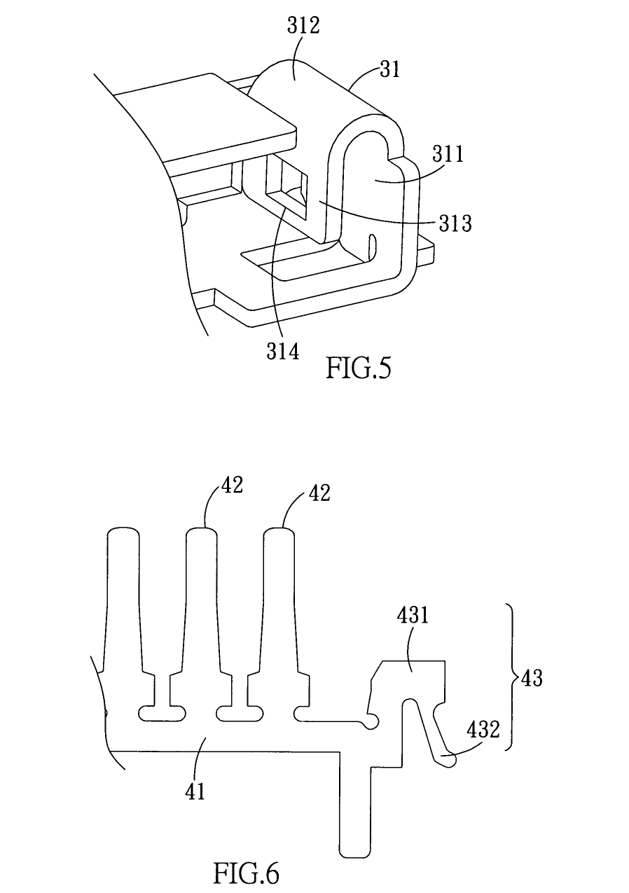

Referring to FIG. 6, the grounding plate 40 mainly comprises a connecting portion 41, a plurality of distal ends 42 and lock portions 43. The distal ends 42 extend perpendicularly from the connecting portion 41 and are aligned in parallel. The lock portions 43 are formed at both sides of the connecting portion 41. Each lock portion 43 includes a fixing portion 431 and a resilient arm 432 extending diagonally from an end of the fixing portion 431 for resiliently locking the shell 3, as shown in FIG. 6. During assembly, the grounding plate 40 is inserted from the rear surface 12 of the insulative housing 10. The distal ends 42 are inserted along the individual lower passageways 16. Within the opening 15, the distal ends 42 correspond to the contact ends 21 of the terminals 20 when the grounding plate 40 is assembled on the insulative housing 10. In use, the mating flexible cable is inserted into the opening 15 and is held by the contact ends 21 and the distal ends 42.

In a normal assembling process, the shell 30 is assembled onto the insulative housing 10 from a rear thereof. The curve portions 312 of the shell 30 extend through the slits 181, and the inner portions 313 are retained in side walls (not labeled) of the cavities 18. The slots 314 of the inner portion 313 are integrated with the shell 30, and therefore have retention to fix the mating flexible cable. The terminals 20 and the grounding plate 40 are inserted into the upper and lower passageways 16, respectively. The fixing portions 431 of the lock portions 43 are embedded into the fixing grooves 17 of the insulative housing 10. The resilient arms 432 of the lock portions 43 resiliently lock a rear side of the shell 30. The grounding plate 40 is easily assembled, and reduces deformation with respect to the shell 30 owing to the resilient arms 432.

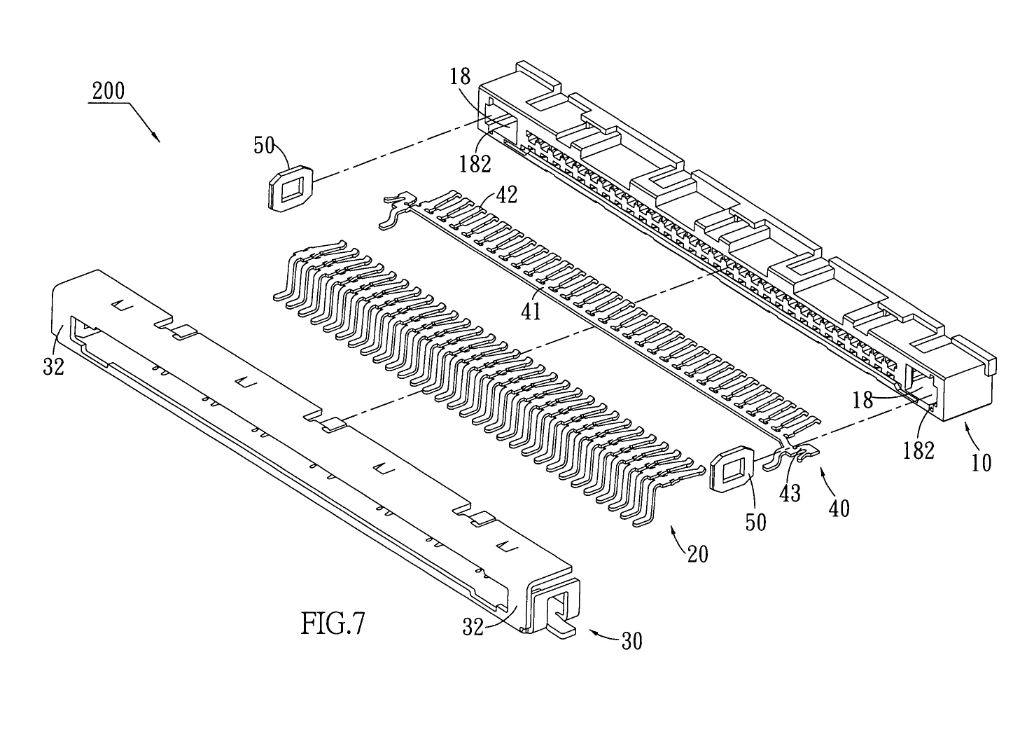

Locking structures may be substituted, as shown in FIG. 7. An electrical connector 200 according to a second embodiment of the invention comprises an insulative housing 10, a plurality of terminals 20, a shell 30 and a grounding plate 40. The shell 30 includes a pair of separate latching elements 50 instead of inverted U-shaped latches 31 formed thereon in the first embodiment. Sliding grooves 182 are defined in opposite sides of the opening 15 and respectively communicate with the cavities 18. In assembly, the latching elements 50 are mounted on the sliding grooves 182. The shell 30 is assembled on the insulative housing 10. Stop portions 32 of the shell 30 are provided at rear ends of the sliding grooves 182 for preventing the latching elements 50 from escaping from the sliding grooves 182. Finally the terminals 20 and the grounding plate 40 are assembled to the insulative housing 10. The latching elements 50 are separate, simplifying structure of the shell 30 and diminishing difficulty in manufacture process without lowering retention of the shell 30. Similar to the first embodiment, the grounding plate 40 engages with the shell 30 by the lock portions 43. Each latching element 50 further defines a central hole (not labeled) therein for locking the mating flexible cable.

It is understood that the invention may be embodied in other forms without departing from the spirit thereof. Thus, the present examples and embodiments are to be considered in all respects as illustrative and not restrictive, and the invention is not to be limited to the details given herein.

1. An electrical connector comprising:
a rectangular insulative housing defining an opening through a front surface thereof and a plurality of passageways therein;
a plurality of terminals received in the passageways;
a shell enveloping the insulative housing; and
a grounding plate assembled on the insulative housing, and including a connecting portion, a plurality of distal ends extending from the connecting portion, and lock portions extending from both ends of the connecting portion for resiliently holding a side of shell.

2. The electrical connector as claimed in claim 1, wherein each lock portion includes a fixing portion and a resilient arm extending diagonally from an end of the fixing portion for resiliently locking the shell.

3. The electrical connector as claimed in claim 2, wherein fixing grooves extend downwardly from opposite sides of the insulative housing, and wherein the fixing portions of the lock portions are embedded into the fixing grooves.

4. An electrical connector comprising:
a rectangular insulative housing, an opening being defined through a front surface of the insulative housing, sliding grooves being defined at opposing sides of the opening;
a grounding plate assembled on the insulative housing, and including a connecting portion and a plurality of distal ends extending from the connecting portion;
at least a latching element provided in the sliding grooves, and each defining a central hole therein; and
a shell enveloping the insulative housing, at least a stop portion being formed on the shell and located at rear ends of the sliding grooves for limiting the latching elements in the sliding grooves.

5. An electrical connector comprising:
a rectangular insulative housing, an opening being defined through a front surface of the insulative housing, cavities being respectively defined at opposite sides of the opening, slits being respectively defined above the cavities;
a plurality of terminals received in the insulative housing;
a grounding plate assembled on the insulative housing, and including a connecting portion and a plurality of distal ends extending from the connecting portion; and
a shell enveloping the insulative housing, inverted U-shaped latches being formed on both sides of the shell for extending into the slits and being retained on side walls of the insulative housing.
